(19) United States
(12) Patent Application Publication
(10) Pub. No.: US 2025/0198485 A1
(43) Pub. Date: Jun. 19, 2025

(54) MOTOR VEHICLE TRANSMISSION FOR AN AT LEAST PARTIALLY ELECTRICALLY DRIVEN MOTOR VEHICLE

(71) Applicant: ZF Friedrichshafen AG, Friedrichshafen (DE)

(72) Inventors: Johannes Kaltenbach, Friedrichshafen (DE); Thomas Martin, Weissenberg (DE); Fabian Kutter, Kressbronn (DE); Johannes Glückler, Friedrichshafen (DE); Kai Bornträger, Langenargen (DE); Stefan Renner, Ludwigshafen (DE); Stefan Blattner, Ravensburg (DE); Christian Mittelberger, Ravensburg (DE)

(73) Assignee: ZF Friedrichshafen AG, Friedrichshafen (DE)

(21) Appl. No.: 18/980,078

(22) Filed: Dec. 13, 2024

(30) Foreign Application Priority Data
Dec. 14, 2023 (DE) 10 2023 212 681.8

(51) Int. Cl. F16H 3/66

(52) U.S. Cl. CPC F16H 3/66; F16H 2200/0021; F16H 2200/2035

(57) ABSTRACT

A motor vehicle transmission (2) has a first drive input shaft (9), a second drive input shaft (10), a drive output shaft (11), and a first planetary gearset (P1) and a second planetary gearset (P2), where the drive input shafts (9, 10) are each provided for coupling to a respective drive machine. Furthermore, a first shifting device (26) and a second shifting device (27) are provided. In addition, the invention relates to a drive unit (1), a motor vehicle drive axle, a hybrid or electric vehicle and methods for operating a motor vehicle transmission and a drive unit.

### RELATED APPLICATIONS

This application claims the benefit of and right of priority under 35 U.S.C. § 119 to German Patent Application no. 10 2023 212 681.8 filed on 14 Dec. 2023, the contents of which are incorporated herein by reference in its entirety.

### FIELD OF THE DISCLOSURE

The invention relates to a motor vehicle transmission for an at least partially electrically driven motor vehicle, comprising a first drive input shaft, a second drive input shaft, a drive output shaft, and a first planetary gearset and a second planetary gearset, wherein the first drive input shaft is provided for coupling to a first drive machine, in particular a first electric machine, and the second drive input shaft is provided for coupling to a second drive machine, in particular a second electric machine, wherein the first planetary gearset and the second planetary gearset each comprise a first element, a second element and a third element in the form, respectively, of a sun gear, a planetary carrier and a ring gear in each case, wherein to engage various gears precisely two shifting devices are provided in the form of a first shifting device and a second shifting device, wherein the first shifting device comprises a first coupling element which can be positioned in precisely two different gear engagement positions and which, in its second gear engagement position, connects the third element of the first planetary gearset rotationally fixed to the drive output shaft, wherein the first element of the first planetary gearset is connected rotationally fixed to the first drive input shaft, wherein the second element of the first planetary gearset is connected rotationally fixed to the first element of the second planetary gearset, wherein the second element of the second planetary gearset is connected rotationally fixed to the drive output shaft, wherein the third element of the second planetary gearset is immobilized, and wherein the second shifting device comprises a second coupling element which can be positioned in precisely two different gear engagement positions, wherein in its first gear engagement position the second coupling element connects the third element of the first planetary gearset rotationally fixed to the second drive input shaft and in its second gear engagement position it connects the first drive input shaft and the second drive input shaft rotationally fixed to one another. In addition, the invention relates to a drive unit for an at least partially electrically driven motor vehicle, a motor vehicle drive axle for a hybrid or electric vehicle, and methods for operating a motor vehicle transmission and a drive unit.

### BACKGROUND

In motor vehicles designed as electric and hybrid vehicles, as part of a respective drivetrain a motor vehicle transmission is provided between at least one electric machine and drive wheels of the motor vehicle concerned, in order to be able to transmit a drive movement of the at least one electric machine, in particular in the slow range to the drive wheels. Besides transmissions of single-gear design, in some cases motor vehicle transmissions in which two or more gears can be engaged are also used.

From DE 10 2019 216 562 A1 a motor vehicle drive axle of an electric vehicle is known, such that in the motor vehicle drive axle a drive unit with a motor vehicle transmission and two electric machines are provided. The rotors of the two electric machines are in each case connected rotationally fixed to a respectively associated drive input shaft of the motor vehicle transmission. Furthermore, the motor vehicle transmission comprises two planetary gearsets, each of them consisting of a sun gear, a planetary carrier and a ring gear. In addition, the motor vehicle transmission comprises two shifting devices by means of which in each case the function of two shifting elements is reproduced and each of which for that purpose comprises a coupling element. The respective coupling element of the individual shifting devices can be moved, in addition to a neutral position, to precisely two gear engagement positions in which the coupling element forms a rotationally fixed connection between two components of the motor vehicle transmission and thereby brings about an associated power flow via the shifting device concerned. Whereas by means of the first shifting device in the gear engagement positions different gears between the first drive input shaft and a drive output shaft of the motor vehicle transmission can be engaged in order to connect the electric machine connected to the first drive input shaft in these gears, by means of the other shifting device on the one hand a rotationally fixed connection of the second drive input shaft to the first drive input shaft can be produced, whereby the gears that can be engaged between the first drive input shaft and the drive output shaft can also be used for the electric machine connected to the second drive input shaft. On the other hand, however, by way of the other shifting device the second drive input shaft can be coupled to the first planetary gearset.

### SUMMARY

Starting from the above-described prior art the purpose of the present invention is now to produce a design of a motor vehicle transmission alternative to that of the prior art for connecting two electric machines.

the present disclosure relates to a motor vehicle transmission as variously disclosed herein. A drive unit in which a motor vehicle transmission according to the invention is provided, is also disclosed. In addition, the present disclosure relates to a motor vehicle drive axle for a hybrid or electric vehicle, as well as a hybrid or electric vehicle. The present disclosure also relates to a method for operating a motor vehicle transmission and to a method for operating a drive unit. Additional advantages and further developments will be apparent from the present disclosure.

According to the invention, a motor vehicle transmission comprises a first drive input shaft, a second drive input shaft, a drive output shaft and a first planetary gearset and a second planetary gearset. The first drive input shaft is designed to be coupled to a first drive machine, in particular a first electric machine, and the second drive input shaft is designed to be coupled to a second drive machine, in particular a second electric machine. The first and second planetary gearsets comprise in each respective case a first element, a second element and a third element, respectively in the form of a sun gear, a planetary carrier and a ring gear. To engage various gears between the individual drive input shafts and the drive output shaft, precisely two shifting devices in the form of a first shifting device and a second shifting device are provided, wherein the first shifting device comprises a first coupling element which can be positioned in precisely two different gear engagement positions, and which in its second gear engagement position connects the third element of the first planetary gearset rotationally fixed to the drive output shaft. Furthermore, the first element of the first planetary gearset is connected rotationally fixed to the first drive input shaft, while in contrast the second element of the first planetary gearset is connected rotationally fixed to the first element of the second planetary gearset. The second element of the second planetary gearset is connected rotationally fixed to the drive output shaft, and the third element of the second planetary gearset is immobilized. Furthermore, the second shifting device comprises a second coupling element which can be positioned in precisely two different gear engagement positions, such that in its first gear engagement position the second coupling element connects the third element of the first planetary gearset rotationally fixed to the second drive input shaft and in its second gear engagement position it connects the first drive input shaft and the second drive input shaft rotationally fixed to one another.

In the context of the invention, a “shaft” such as the respective drive input shaft or the drive output shaft, is understood to be a rotating component of the transmission by means of which a power flow between components can be produced. The shaft concerned can connect the components axially or radially or even both axially and radially. Thus, the shaft concerned can also be an intermediate component by which a particular component can for example be connected purely radially. Furthermore, depending on its shape and connection or connectivity to the components, the shaft concerned can be a solid shaft, a hollow shaft or a shaft that is partly solid and partly hollow. Alternatively, or in addition, the shaft can be made integrally in one piece or in more than one piece.

In the context of the invention, “axial” means in the direction of a longitudinal central axis of the motor vehicle transmission, parallel to which rotation axes of shafts of the motor vehicle transmission and elements of the planetary gearsets are also orientated. Then, “radial” means an orientation in the direction of the diameter of a particular component of the transmission, especially a particular shaft or a particular element of the planetary gearsets.

The motor vehicle transmission according to the invention comprises a first drive input shaft and a second drive input shaft, these two drive input shafts being arranged in particular coaxially with one another. In this case, in the motor vehicle transmission according to the invention the two drive input shafts are provided to be coupled on the drive input side to a respective drive machine, wherein each drive input shaft is preferably coupled to just one drive machine. For that purpose, each drive input shaft is designed in particular with a connection point at which the drive input shaft concerned can be coupled to its associated drive machine. In the installed condition of the motor vehicle transmission the associated drive machine is in particular connected permanently to the connection point of the drive input shaft concerned, preferably when the drive machine is in the form of an electric machine. Alternatively, however, an intermediate starting element such as a hydrodynamic torque converter, a starting clutch, etc., can be provided, by way of which the respective drive input shaft is or can be coupled at its connection point to the associated upstream drive machine. This is done in particular when the associated drive machine is an internal combustion engine.

The coupling between the associated drive machine and the drive input shaft concerned is preferably such that in the installed state of the motor vehicle transmission, there is always a fixed rotation speed ratio between the rotation speed of the drive input shaft of the motor vehicle transmission and the rotation speed of the drive machine associated with it. Thus, in the context of the invention at least one further transmission ratio step can still be provided between the drive input shaft and the associated drive machine, such as a spur gear stage and/or a planetary gearset, by means of which a preliminary gear ratio between a rotation movement of the drive machine and the drive input shaft can be produced. Preferably however, the drive input shaft concerned is connected rotationally fixed to the associated drive machine.

The motor vehicle transmission is in particular a transmission for a hybrid or electric vehicle, which transmission is provided in order to be connected to a respective drive machine in the form of an electric machine by way of the drive input shaft concerned. As described earlier, a rotor of the electric machine can be coupled via at least one intermediate gear ratio step to the respective drive input shaft of the motor vehicle transmission. Particularly preferably however, in the installed state of the motor vehicle transmission the rotor of the electric machine concerned is connected rotationally fixed to the associated drive input shaft.

In the motor vehicle transmission according to the invention, the drive output shaft is provided in particular to form a coupling of the motor vehicle transmission on the drive output side to components which, in the installed condition of the motor vehicle transmission, are downstream in the power flow toward drive wheels of the motor vehicle concerned. Correspondingly, the motor vehicle transmission according to the invention is in particular a driving transmission by means of which at least one of the drive machines can be coupled to drive wheels of the motor vehicle in order to transmit a respective drive movement with various gear ratios to the drive wheels. In this, the motor vehicle transmission according to the invention can be coupled via the drive output shaft in particular to a differential gearset, which is positioned coaxially or with an axial offset relative to the drive output shaft and can thus function as a transverse or longitudinal differential. That coupling can be done by way of a gear ratio step in the form of a bevel gear transmission. Alternatively, the drive output shaft can also be connected rotationally fixed to the downstream differential gearset or it can be coupled via an intermediate gear ratio step, for example in the form of an additional planetary gearset.

The first planetary gearset and the second planetary gearset each consist of a first element, a second element, and a third element respectively, wherein the elements of the first and second planetary gearsets consist of a sun gear, a planetary carrier, and a ring gear in each case. Particularly preferably, the first and second planetary gearsets are in the form of minus planetary gearsets, in which on the respective planetary carrier at least one planetary gearwheel is mounted to rotate, the gearwheel meshing both with the sun gear and with the ring gear. In a design of the first and second planetary gearsets as minus planetary gearsets, the respective first element of the first and second planetary gearsets is the sun gear, the second element of the first and second planetary gearsets is the planetary carrier and the third element of the first and second planetary gearsets is the ring gear.

Alternatively, the first planetary gearset and/or the second planetary gearset could in principle be designed as plus planetary gearsets. In that case at least one pair of planetary gearwheels is mounted to rotate on each planetary carrier, and of those planetary gearwheels one meshes with the respective sun gear and the other planetary gearwheel meshes with the ring gear. Moreover, the planetary gearwheels of the at least one planetary gearwheel pair mesh with one another. Other than in the design as minus planetary gearsets, the first element of the first and second planetary gearsets is preferably the sun gear but their second element is the ring gear, and the third element is their planetary carrier. Compared with the minus planetary gearset design, a stationary gear ratio of the planetary gearset concerned must also be increased by one. As already described earlier, however, in the context of the present invention the first and second planetary gearsets are preferably both minus planetary gearsets. Particularly preferably, the motor vehicle transmission according to the invention comprises precisely two planetary gearsets, namely the first and second planetary gearsets.

For the engagement of various gears, the motor vehicle transmission according to the invention has just two shifting devices, by the selective actuation of which the various gears can be engaged. The first and second shifting devices each comprise a respective coupling element, such that both the first coupling element, that of the first shifting device, and the second coupling element, that of the second shifting device, can move to precisely two gear engagement positions in each case. In the context of the invention, a “gear engagement position” is understood to mean a position or a position range in which the coupling element concerned has to be positioned in order to produce a power flow by way of the shifting device by forming a rotationally fixed connection between components of the motor vehicle transmission. By means of the coupling elements of the shifting devices concerned in their respective gear engagement positions, various rotationally fixed connections are produced and thereby also force flow paths through the shifting devices that differ from one another are created.

The invention is now based on the technical principle that the first coupling element in its first gear engagement position immobilizes the third element of the first planetary gearset. Thus, besides the rotationally fixed connection of the third element of the first planetary to the drive output shaft, by means of the first sifting device the first element of the second planetary gearset can also be immobilized.

Thus, in the motor vehicle transmission according to the invention the first element of the first planetary gearset and the first drive input shaft are permanently connected rotationally fixed to one another, so that the first drive input shaft and the first element of the first planetary gearset always rotate together. Furthermore, the second element of the first planetary gearset and the first element of the second planetary gearset are permanently connected rotationally fixed to one another, which means that the second element of the first planetary gearset and the first element of the second planetary gearset always rotate together. There is also a permanent rotationally fixed connection between the drive output shaft and the second element of the second planetary gearset, whereby the drive output shaft and the second element of the second planetary gearset always rotate together. Moreover, the third element of the second planetary gearset is permanently immobilized, i.e., it is permanently prevented from rotating.

By means of the first shifting device the third element of the first planetary gearset can be coupled in various ways, in that the first coupling element of the first shifting device in its first gear engagement position immobilizes the third element of the first planetary gearset, whereas the first coupling element of the first shifting device in its second gear engagement position connects the third element of the first planetary gearset rotationally fixed to the drive output shaft.

In particular, the first coupling element, in its two gear engagement positions and while being displaced axially between them, is guided rotationally fixed but axially movably on a first tooth array, which is connected rotationally fixed to the third element of the first planetary gearset. In the first gear engagement position the first coupling element then preferably maintains the existing engagement with the first tooth array in a second tooth array, which is permanently immobilized. On the other hand, if the first coupling element of the first shifting device is moved to its second gear engagement position, then in addition to the tooth engagement with the first tooth array the first coupling element engages with a third tooth array which is connected rotationally fixed to the drive output shaft.

Particularly preferably, the first coupling element of the first shifting device is in the form of a sliding sleeve, which in this case has in particular one or more coupling tooth arrays. Preferably, on these one or more coupling tooth arrays the axial rotationally fixed guiding on the first tooth array and/or the respective engagement in the second and third tooth arrays take place. The teeth are preferably in the form of claw teeth, so that the first shifting device is then designed as an unsynchronized shifting device.

By means of the second shifting device, various rotationally fixed connections of the second drive input can be produced, in that the second coupling element of the second shifting device, in its first gear engagement position, connects the second drive input shaft rotationally fixed to the third element of the first planetary gearset and in its second gear engagement position it connects the second drive input shaft rotationally fixed to the first drive input shaft. The second shifting device is designed in particular such that the second coupling element, in its two gear engagement positions and when moving axially between them, is guided on a first tooth array in a rotationally fixed but axially displaceable manner, the tooth array being connected rotationally fixed to the second drive input shaft. In its first gear engagement position the second coupling element then preferably also engages in a second tooth array which is connected permanently rotationally fixed to the third element of the first planetary gearset. In contrast, in its second gear engagement position, in addition to its tooth engagement with the first tooth array, the second coupling element engages with a third tooth array which is connected rotationally fixed to the first drive input shaft.

The second coupling element of the second shifting device is in particular in the form of a sliding sleeve and the second coupling element preferably has one or more coupling tooth arrays on which in each case the axially rotationally fixed guiding on the first tooth array occurs and/or the respective engagement in the second and third tooth arrays can take place. The teeth are preferably in the form of claw teeth, so that the second shifting device is designed as an unsynchronized shifting device.

The design of the motor vehicle transmission in accordance with the invention has the advantage that it results in a structure of the motor vehicle transmission with which suitable connections of the drive machines connected to the drive input shafts can be realized. Since the motor vehicle transmission in this case consists essentially of the two planetary gearsets and the two shifting devices, the structure of the motor vehicle transmission is also more compact and its production costs are lower.

In the motor vehicle transmission according to the invention, the drive input shafts and the drive output shaft are in particular arranged coaxially with one another, and also preferably the planetary gearsets are positioned coaxially with the drive input shafts and the drive output shaft. Consequently, the structure of the motor vehicle transmission is particularly compact in the radial direction.

In the context of the invention, a “permanent rotationally fixed connection” of components of the transmission is understood to mean that these components connected rotationally fixed or brought into rotationally fixed connection with one another are connected solidly with one another and consequently rotate at the same rotation speed. The components connected rotationally fixed or brought into rotationally fixed connection with one another can be separate components fixed to one another. Alternatively, components connected rotationally fixed or brought into rotationally fixed connection with one another can be made integrally and are therefore in the form of a conjoint component. This is done in particular when the components are positioned spatially close to one another.

In the context of the invention, an immobilized state of a component of the motor vehicle transmission is produced in particular when a rotationally fixed connection is formed to a permanently immobile component, which can be a housing of the motor vehicle transmission, part of such a housing or a component permanently attached rotationally fixed thereto. In the present case the third element of the second planetary gearset is permanently connected rotationally fixed to the immobile component, and in such a case too a one-piece design of the third element of the second planetary gearset and the immobile component would be conceivable.

In the context of the invention, an immobilization of a component of the motor vehicle transmission by means of a coupling element of the shifting devices or a rotationally fixed connection between components of the motor vehicle transmission by means of a coupling element of the shifting devices means that the component concerned is not permanently immobilized or the components are not permanently coupled to one another, but rather, that an immobilization or a rotationally fixed connection is only produced when the coupling element of the shifting device concerned is in the corresponding gear engagement position.

In the context of the invention, the motor vehicle transmission according to the invention can be operated in such manner that a first gear between the first drive input shaft and the drive output shaft is engaged when the first coupling element is moved to its first gear engagement position. This first gear can also be obtained simultaneously between the two drive input shafts and the drive output shaft when the second coupling element is moved to its second gear engagement position in addition to the first coupling element being in its first gear engagement position. Furthermore, a second gear between the first drive input shaft and the drive output shaft can be engaged when the first coupling element is moved to its second gear engagement position, and the second gear can be engaged simultaneously between the two drive input shafts and the drive output shaft when the second coupling element is moved to its second gear engagement position in addition to the first coupling element being in its second gear engagement position. Advantageously, in that way on the one hand driving exclusively by way of the first drive machine connected to the first drive input shaft can be carried out. On the other hand, however, if necessary simultaneous driving by both drive machines can take place, both in the first gear and also in the second gear, for which purpose, with the first coupling element in one of the two gear engagement positions, at the same time the second coupling element is positioned in its second gear engagement position.

Furthermore, in the motor vehicle transmission according to the invention a superimposition of drive movements of the two drive machines can be realized since in the two shifting devices only the second coupling element is moved to its first gear engagement position. In that way the drive machines connected to the drive input shafts can support each other with a fixed torque ratio and variable rotation speed. In this case a torque ratio of the two drive input shafts corresponds to the value of a stationary gear ratio of the first planetary gearset. Consequently, the motor vehicle transmission is suitable for the connection of drive machines of different sizes, wherein in that case the second drive machine should in particular deliver a higher drive input torque than the first drive machine. However, the connection of the second drive input shaft by way of the second coupling element in its first gear engagement position can also be used to support the traction force by means of the second drive machine when the first coupling element is being shifted between its gear engagement positions.

Due to the exclusive movement of the second coupling element to its first gear engagement position, a third gear can also be reproduced between the two drive input shafts and the drive output shaft, if during operation the torques of the two drive machines connected to the drive input shafts are matched to one another and thereby, due to the superimposition at the second planetary gearset, a suitable traction force for obtaining the third gear is produced at the drive output shaft. This third gear can be produced without having to provide an additional shifting element in the motor vehicle transmission. Preferably, at the two drive input shafts the same rotation speed and a torque ratio is set which corresponds to the value of a stationary gear ratio of the first planetary gearset.

In an embodiment of the invention, the first shifting device is arranged axially on a side of the first planetary gearset facing away from the second planetary gearset. Alternatively, but preferably in addition thereto, the second shifting device is positioned axially at least overlapping and radially surrounding the first planetary gearset.

According to a possible design of the invention, the first coupling element of the first shifting device can also be moved to a neutral position between its two gear engagement positions, in which the first coupling element neither connects the third element of the first planetary gearset rotationally fixed to the drive output shaft, nor immobilizes the third element of the first planetary gearset. In that way the first drive input shaft can be decoupled from the drive output shaft.

Alternatively, but preferably in addition, the second coupling element of the second shifting device can also be moved to a neutral position between its two gear engagement positions, in which the second coupling element neither connects the third element of the first planetary gearset rotationally fixed to the second drive input shaft, nor brings the first drive input shaft and the second drive input shaft into rotationally fixed connection with one another. In that way the second drive machine connected to the second drive input shaft can be decoupled from the drive output shaft by moving the second shifting device to its neutral position.

An object of the invention is to provide a drive unit, which besides a first electric machine and a second electric machine, also comprises a motor vehicle transmission according to one or more of the above-described variants. In this embodiment, a rotor of the first electric machine is coupled to the first drive input shaft of the motor vehicle transmission, while a rotor of the second electric machine is coupled to the second drive input shaft. In the context of the invention each electric machine concerned can in particular be operated on the one hand as a generator and on the other hand as an electric motor. In that way a drive unit can be provided, which is suitable for use in a motor vehicle in the form of a hybrid or an electric vehicle. The two electric machines can be sized such that they have the same power, although preferably the electric machines have different powers.

Particularly preferably, the first electric machine is arranged coaxially with the first drive input shaft and the rotor of the first electric machine is connected rotationally fixed to the first drive input shaft. In that way, during operation the first drive input shaft and the rotor of the first electric machine rotate at the same rotation speed. Alternatively, however, the rotor of the first electric machine can be coupled to the first drive input shaft via at least one gear ratio step.

Alternatively, preferred but in addition thereto, in a drive unit according to the invention the second electric machine is in particular arranged coaxially with the second drive input shaft of the motor vehicle transmission with the rotor of the second electric machine connected rotationally fixed to the second drive input shaft. Accordingly, during operation, the rotor of the second electric machine and the second drive input shaft both rotate at the same rotation speed. Alternatively, however, the rotor of the second electric machine can be coupled to the second drive input shaft via at least one intermediate gear ratio step.

The drive unit according to the invention can on the one hand be operated in such manner that a gearshift between a first gear of the motor vehicle transmission acting between the two drive input shafts and the drive output shaft and a second gear of the motor vehicle transmission acting between the two drive input shafts and the drive output shaft can be carried out under load. For that purpose, at the beginning of the gearshift the second shifting device of the motor vehicle transmission is first changed from the second gear engagement position of the second coupling element to the first gear engagement position of the second coupling element, and during the course of that change a rotation speed synchronization is carried out at the second shifting device by the second electric machine and a traction force is supported by means of the first electric machine. Thereafter, in the first shifting device the first coupling element is moved away from its current gear engagement position, i.e., from the gear engagement position that corresponds to the gear engaged at the time, to its neutral position and for that a load-free state of the first coupling element is produced by an interaction of the two electric machines. That is possible because in the overlap range the second coupling element is still in its first gear engagement position. Following this, in the first shifting device the first coupling element is moved from its neutral position to its target gear engagement position, i.e., to the gear engagement position that corresponds to the gear that is to be engaged, and for that purpose a rotation speed synchronization at the first shifting device is carried out by the first electric machine. Finally, in the second shifting device of the motor vehicle transmission the second coupling element is shifted from its first gear engagement position to its second gear engagement position and during the course of that shift a rotation speed synchronization at the second shifting device is carried out by the second electric machine and the traction force is supported by the first electric machine. Thus, gearshifts between the first gear and the second gear can be carried out as powershifts.

Alternatively, with the drive unit according to the invention a change can be carried out between a first gear of the motor vehicle transmission acting between the two drive input shafts and the drive output shaft and a second gear of the motor vehicle transmission acting between the two drive input shafts and the drive output shaft, if in the first shifting device the first coupling element is moved out of its current gear engagement position, i e., the gear engagement position that corresponds to the gear engaged at the time, to its neutral position and for that purpose a load-free condition of the first coupling element is produced by an interaction of the two electric machines. Thereafter, in the first shifting device the first coupling element is moved from the neutral position to its target gear engagement position, i.e., to the gear engagement position which corresponds to the gear that is to be engaged, and for that purpose a rotation speed synchronization is carried out in the first shifting device by means of both electric machines.

In a further development of one of the two methods described above, depending on the rotation speeds of the two electric machines, in the second gear acting between the two drive input shafts and the drive output shaft a shift is also carried out to a third gear that can be reproduced in the motor vehicle transmission, in that first of all, in the second shifting device of the motor vehicle transmission a shift is carried out from the second gear engagement position of the second coupling element to the first gear engagement position of the second coupling element, and during the course of that shift a rotation speed synchronization is carried out at the second shifting device by the second electric machine, and a traction force is supported by the first electric machine. Then, by the interaction of the two electric machines a load-free condition of the first coupling element is produced and after that, in the first shifting device, the first coupling element is moved out of its second gear engagement position to its neutral position. In that way overlapping operation at the second planetary gearset is obtained and the two electric machines can then have rotation speeds that correspond with one another, or which are at least similar to one another.

In accordance with a possible design of a drive unit according to the invention, the first planetary gearset of the motor vehicle transmission is arranged axially at least partially overlapping and radially inside the rotor of the first electric machine. In that way a nested and thus also more compact structure of the drive unit can be produced.

Alternatively, but preferably in addition thereto, the second planetary gearset is arranged axially at least partially overlapping and radially inside the rotor of the second electric machine. Also preferably, the second shifting device of the motor vehicle transmission is arranged axially at least partially overlapping and radially inside the rotor of the second electric machine. Advantageously, by virtue of the nested structure produced in that manner the axial structural length of the drive unit can be reduced and a more compact configuration created.

A drive unit designed in accordance with one or more of the above variants is in particular part of a motor vehicle drive axle which is in this context provided for a hybrid or electric vehicle. Preferably, the drive unit is arranged in the same plane as drive output shafts, each of the latter being associated with at least one drive wheel and being coupled to the drive output shaft of the motor vehicle transmission. Advantageously, in that way a more compact structure of a motor vehicle drive axle with the drive unit can be produced, wherein the coupling between the drive output shaft of the motor vehicle transmission and the drive input shafts of the motor vehicle drive axle is in particular formed via a differential gearset.

In the context of the invention, at least one such motor vehicle drive axle is provided in a hybrid or electric vehicle, which vehicle can be a passenger car or a utility vehicle. In this case a utility vehicle can be an at least partially electrically driven transporter or a lightweight or medium-weight bus or truck.

### BRIEF DESCRIPTION OF THE DRAWINGS

Advantageous embodiments of the invention, which are explained below, are illustrated in the drawings, which show:

FIG. 1: A schematic view of a drive unit according to an embodiment of the invention;

FIG. 2: A representation in the form of a table, of various conditions of the drive unit shown in FIG. 1; and

FIG. 3: A schematic view of an electric vehicle corresponding to a preferred embodiment of the invention.

### DETAILED DESCRIPTION

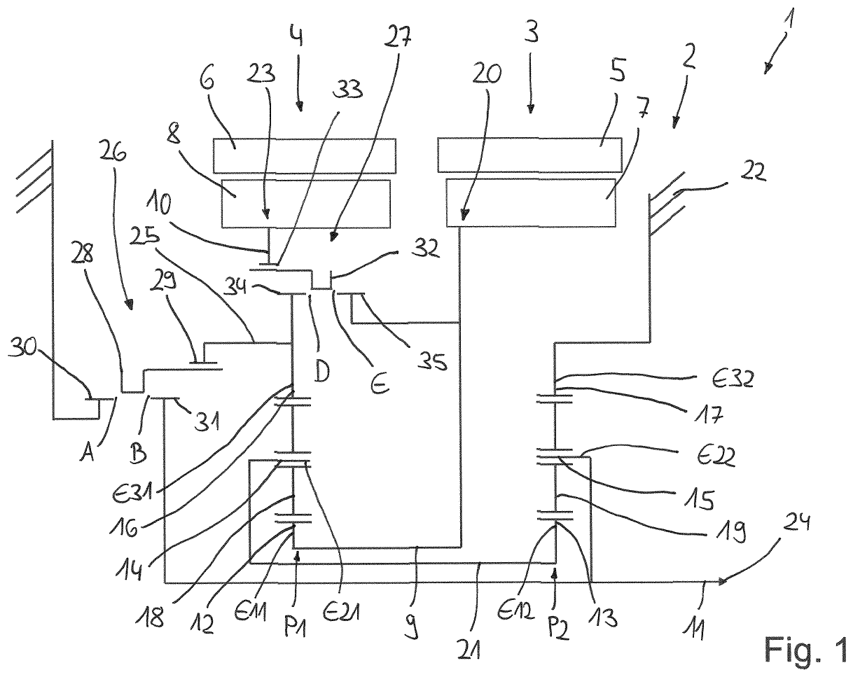

FIG. 1 shows a schematic view of a drive unit 1 designed in accordance with an embodiment of the invention. This drive unit 1 consists of a motor vehicle transmission 2 and two electric machines 3 and 4, such that in this case the motor vehicle transmission 2 is designed in accordance with a first embodiment of the invention. In a manner whose principle is familiar to those with a knowledge of the field, the two electric machines 3 and 4 each comprise a stator 5 and 6 and a rotor 7 and 8, respectively, and the individual electric machines 3 and 4 can be operated on the one hand as a generator and on the other hand as an electric motor.

The motor vehicle transmission 2 comprises a first drive input shaft 9, a second drive input shaft 10, a drive output shaft 11 and two planetary gearsets P1 and P2, each of them consisting of a first element E11 or E12, a second element E21 or E22 and a third element E31 or E32 respectively. The first element E11 or E12 of the first or second planetary gearset P1 or P2 is in each case a sun gear 12 or 13, whereas the second element E21 or E22 of the planetary gearset P1 or P2 is a planetary carrier 14 or 15. In addition the third element E31 or E32 of the planetary gearset P1 or P2 is in each case a ring gear 16 or 17 of the planetary gearset P1 or P2.

On the respective planetary carrier 14 or 15 of the planetary gearset P1 or P2, in each case at least one planetary gearwheel 18 or 19 is mounted to rotate, which meshes both with the associated sun gear 12 or 13 and also with the associated ring gear 16 or 17. Accordingly, in this case the planetary gearsets P1 and P2 are minus planetary gearsets.

In the present case the first element E11 of the first planetary gearset P1 is connected rotationally fixed to the first drive input shaft 9, which in addition is connected rotationally fixed at a connection point 20 to the rotor 7 of the electric machine 3. Thus, the first element E11 of the first planetary gearset P1 and the rotor 7 are connected rotationally fixed to one another via the first drive input shaft 9, whereby the first element E11 and the rotor 7 always rotate at the same rotation speed. Within the scope of the invention the first element drive input 9 can be made integrally with the first element E11 of the first planetary gearset P1 and/or with the rotor 7 of the electric machine 3.

The second element E21 of the first planetary gearset P1 and the first element E12 of the second planetary gearset P2 are permanently connected rotationally fixed to one another, this rotationally fixed connection being produced by way of a shaft 21 which can if necessary be made integrally with the second element E12 of the first planetary gearset P1 and/or with the first element E12 of the second planetary gearset P2. The third element E32 of the second planetary gearset P2 is permanently connected to a permanently immobile structural element 22, which can be a transmission housing of the motor vehicle transmission 2, part of the transmission housing or a component connected rotationally fixed thereto. In the transmission housing of the motor vehicle transmission 2, in this case besides components of the motor vehicle transmission 2 itself the two electric machines 3 and 4 are preferably also accommodated. Owing to the permanently rotationally fixed connection to the rotationally fixed structural element 22 the third element E32 of the second planetary gearset P2 is permanently prevented from rotating.

As can be seen in FIG. 1 the second drive input shaft 10 is connected rotationally fixed to the rotor 8 of the electric machine 4, so that the second drive input shaft 10 and the rotor 8 always rotate at the same rotation speed. The rotationally fixed connection to the rotor 8 is made in this case at a connection point 23 of the second drive input shaft 10, so that the second drive input shaft 10 and the rotor 8 of the electric machine 4 can also be made integrally. The drive output shaft 11 is connected rotationally fixed to the second element E22 of the second planetary gearset P2, and the drive output shaft 11 is in particular connected farther downstream at a connection point 24 to a differential gearset of a differential gear system-not shown here. Moreover. the third element E31 of the first planetary gearset P1 is connected rotationally fixed to a shaft 25, so that the shaft 25 and the third element E31 of the first planetary gearset P1 could also be made integrally.

In addition, the motor vehicle transmission 2 comprises two shifting devices 26 and 27, by means of which the function of four shifting elements A, B, D, and E are reproduced. The shifting device 26 comprises a coupling element 28 in the form of a shifting sleeve, which can be moved to a first gear engagement position, a second gear engagement position and a neutral position between them. This positioning is done by means of an actuator—none of which is shown here. The coupling element 28 of the shifting device 26 is guided rotationally fixed but axially displaceably on a tooth array 29, which is connected rotationally fixed to the shaft 25 and thus also to the third element E31 of the first planetary gearset P1.

From its neutral position shown in FIG. 1, the coupling element 28 can on the one hand be moved to the first gear engagement position, in which the coupling element 28, while still meshing with the tooth array 29, also engages in a tooth array 30 which is connected rotationally fixed to the permanently immobile structural element 22 and is therefore also permanently immobilized. Correspondingly, this results in the immobilization of the shaft 25 and hence also of the third element E31 of the first planetary gearset P1. In the first gear engagement position of the coupling element 28 the actuated state of the shifting element A is produced.

On the other hand, the coupling element 28 can be moved from its neutral position to the second gear engagement position, in which the coupling element 28, while still engaged with the tooth array 29, also engages with a tooth array 31 which is connected rotationally fixed to the drive output shaft 11 and therefore also to the second element E22 of the second planetary gearset P2. Thus, in the second gear engagement position of the coupling element 28 the actuated state of the shifting element B is produced.

In the shifting device 27, a coupling element 32 in the form of a shifting sleeve is provided as well, which by means of an actuator—not shown here—besides the neutral position shown in FIG. 1, can be moved on the one hand to a first gear engagement position and on the other hand to a second gear engagement position. The coupling element 32 is guided always in a rotationally fixed manner but axially displaceably on a tooth array 33, which is connected rotationally fixed to the second drive input shaft 10. When the coupling element 32 is positioned in its first gear engagement position an actuated state of the shifting element D is produced, wherein the coupling element 32, while still engaged with the tooth array 33, also engages with a tooth array 34 which is connected rotationally fixed to the shaft 25 and therefore also to the third element E31 of the first planetary gearset P1.

In contrast, if the coupling element 32 is moved from the neutral position to its second gear engagement position, then by virtue of the shifting device 27 an actuated state of the shifting element E is produced. In this second gear engagement position, while still engaged with the tooth array 33 the coupling element 32 also engages with a tooth array 35 which is connected rotationally fixed to the first drive input shaft 9. Thus, in the second gear engagement position of the coupling element 32 a rotationally fixed connection is produced between the second drive input shaft 10 and the first drive input shaft 9.

As can be seen in FIG. 1, the first drive input shaft 9, the second drive input shaft 10, the drive output shaft 11 and also the planetary gearsets P1 and P2 are arranged coaxially with one another and in addition, besides the shafts 21 and 25 the two electric machines 3 and 4 as well are positioned coaxially thereto. Of the planetary gearsets P1 and P2 the second planetary gearset P2 is in this case located axially close to the connection point 24 of the drive output shaft 11.

In the present case, the second planetary gearset P2 is arranged axially overlapping the first electric machine 3 and the second planetary gearset P2 is positioned radially inside the first electric machine 3. The first planetary gearset P1 is positioned axially overlapping and radially inside the second electric machine 4, the shifting device 27 also axially overlaps the second electric machine 4 and partially overlaps the first planetary gearset P1, and is in this case arranged radially between the first planetary gearset P1 and the second electric machine 4. The shifting device 26 is located axially on a side of the first planetary gearset P1 that faces away from the second planetary gearset P2, and radially overlaps with the first planetary gearset P1.

Whereas the drive output shaft 11 is made essentially as a solid shaft and, starting from the connection point 24, extends almost over the full axial length of the motor vehicle transmission 2, the first drive input shaft 9, the second drive input shaft 10 and the shafts 21 and 25 are hollow shafts. The first drive input shaft 9 runs axially between the first planetary gearset P1 and the second planetary gearset P2 and, starting from the first element E11 of the first planetary gearset P1, extends radially outward as far as the electric machine 3, while the second drive input shaft 10 is in the form of a short radial connecting piece and extends radially between the shifting device 27 and the rotor 8 of the electric machine 4. Starting from the second planetary gearset P2, the shaft 21 extends on a side of the first planetary gearset P1 facing away from the second planetary gearset P2, in such manner that after passing through the first planetary gearset P1 the shaft 21 extends radially outward to be connected to the second element E21 of the first planetary gearset P1. Moreover, starting from the first planetary gearset P1, the shaft 25 extends axially to the shifting device 26.

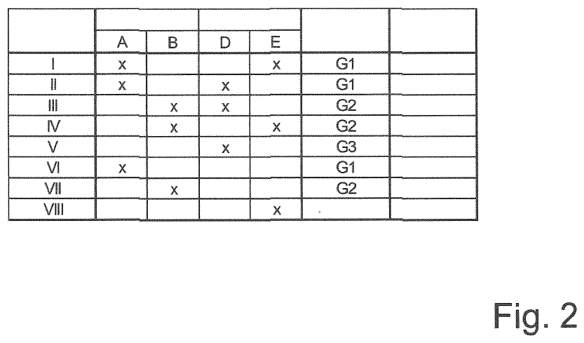

FIG. 2 shows a tabulated summary of various conditions I to VIII which can be produced by the drive unit 1 of FIG. 1. In this case, in conditions I, II and VI a first gear G1 is engaged in the motor vehicle transmission 2 of the drive unit 1, for which purpose the coupling element 28 of the shifting device 26 is moved to its first gear engagement position (actuated state of A). In that way the shaft 25 and so also the third element E31 of the first planetary gearset P1 are immobilized, so that the first drive input shaft 9 is coupled to the drive output shaft 11 by both planetary gearsets P1 and P2.

In condition I, in addition the coupling element 32 of the shifting device 27 is shifted to its second gear engagement position (actuated state of E), so that the second drive input shaft 10 is also connected rotationally fixed to the first drive input shaft 9. Accordingly, in the condition I both electric machines 3 and 4 participate in the first gear G1, whereby conjoint driving by the electric machines 3 and 4 can take place.

In contrast, in the condition II, besides the positioning of the coupling element 28 of the shifting device 26 in its first gear engagement position, the coupling element 32 of the shifting device 27 is moved to its first gear engagement position (actuated state of D), whereby the second drive input shaft 10 is connected rotationally fixed to the shaft 25 and is therefore immobilized along with the latter. Then the electric machine 4, whose rotor 8 is thereby also immobilized in condition II, can be used to support the traction force by switching over in the shifting device 26, and also for synchronizing the shifting device 26.

In contrast, in condition VI only the first drive input shaft 9 is coupled to the drive output shaft 11 and thus also only the electric machine 3 is involved, whereas the electric machine 4 is decoupled. For that purpose, the neutral position of the coupling element 32 in the shifting device 27 should be set, while the coupling element 28 in the shifting device 28 is positioned in its first gear engagement position. In that way drag losses in the electric machine 4 can be avoided.

A second gear G2 can be engaged in the motor vehicle transmission 2 of the drive unit 1 by moving the coupling element 28 of the shifting device 26 to its second gear engagement position (actuated state of B). This is done in conditions III, IV and VII in each case. In the second gear engagement position of the coupling element 28 the shaft 25 is then connected rotationally fixed to the drive output shaft 11. In that way the first drive input shaft 9 is connected to the drive output shaft 11 by way of both planetary gearsets P1 and P2.

In condition III, in addition, in the shifting device 27 the coupling element 32 is changed to its first gear engagement position (actuated state of D), whereby the second drive input shaft 10 is connected rotationally fixed to the drive output shaft 11. Then, in condition III by means of the electric machine 4 thus also connected rotationally fixed to the drive output shaft 11, the traction force can be supported when switching over in the shifting device 26, the shifting device 26 can be synchronized, and if necessary, the drive output shaft 11 can be driven.

On the other hand, in condition VI a movement of the coupling element 32 of the shifting device 27 to its second gear engagement position (actuated state of E) is also carried out, so that again the two drive input shafts 9 and 10 are connected rotationally fixed to one another. In that way the two drive input shafts 9 and 10 are then coupled to the drive output shaft 11, whereby the two electric machines 3 and 4 both participate in the second gear G2.

Furthermore, only the first drive input shaft 9 and hence the electric machine 3 alone can participate in the second gear G2 (condition VII), for which purpose when the coupling element 28 of the shifting device 26 is in its second gear engagement position, in the shifting device 27 the neutral position of the coupling element 32 should be set. The result is to decouple the electric machine 4, whereby drag losses can be reduced.

In condition V, drive movements of the electric machines 3 and 4 can also be superimposed in a superimposition operating mode, for which purpose in the shifting device 27 the coupling element 32 should be moved to its first gear engagement position (actuated state of D), while the coupling element 28 of shifting device 26 is in its neutral position. In that way the second drive input shaft 10 is connected rotationally fixed to the shaft 25 and hence also to the third element E31 of the first planetary gearset P1, whereas the first drive input shaft 9 is in rotationally fixed connection with the first element E11 of the first planetary gearset P1. In this condition V the electric machines 3 and 4 can support each other's torque with a fixed torque ratio and a variable rotation speed. In this case a torque ratio of the two drive input shafts 9 and 10 and therefore also of the electric machines 3 and 4 corresponds to the value of a stationary gear ratio of the first planetary gearset P1.

Moreover, in condition V, during superimposed operation an additional gear G3 of the motor vehicle transmission 2 can be reproduced. For that purpose, the operations of the two electric machines 3 and 4 have to be matched to one another, whereby due to the superimposition at the first planetary gearset P1, compared with the second gear G2 higher rotation speeds of the drive output shaft 11 and hence also higher driving speeds are reached. In this case the two electric machines 3 and 4 can have the same rotation speed or at least similar rotation speeds.

In contrast, in condition VIII the drive input shafts 9 and 10 are decoupled from the drive output shaft 11, since in the shifting device 26 the coupling element 28 is in its neutral position and in the shifting element 27 the coupling element 32 is moved to its second gear engagement position (actuated state of E). In that case, although the two drive input shafts 9 and 10 are connected rotationally fixed to one another, owing to the free rotation of the shaft 25 no coupling is formed to the drive output shaft 11.

By an appropriate juxtaposition of conditions I to V in the drive unit 1, powershifts in the motor vehicle transmission 2 from the first gear G1 to the second gear G2 can be carried out: to begin with, in condition I the two electric machines 3 and 4 participate in the first gear G1. Then, in the shifting device 27 the coupling element 32 is moved from its second gear engagement position to its first gear engagement position, and during that shift a rotation speed synchronization in the second shifting device 27 is carried out by braking by means of the second electric machine 4, and traction force support by means of the electric machine 3 takes place in the first gear G1. On completion of the shift. the second drive input shaft 10 and hence also the electric machine 4 are braked, and condition II is produced.

Next, a load-free state of the coupling element 28 in the shifting device 28 is produced by setting an appropriate torque ratio between the electric machines 3 and 4, and the coupling element 28 is then moved to its neutral position, thereby producing the condition V. In this condition V, in the superimposition mode as well the traction force is supported and in addition a rotation speed synchronization takes place in the shifting device 26 by appropriately adjusting a rotation speed of the electric machine 3 when the coupling element 28 is moved to its second gear engagement position.

When the coupling element 28 reaches its second gear engagement position, the second gear G2 is engaged between the first drive input shaft 9 and the drive output shaft 11 and the condition III is realized. For the ultimate engagement of the second gear G2 between the two drive input shafts 9 and 10 and the drive output shaft 11, the shifting device 27 is then again switched over so that thereby the electric machine 3 supports the traction force. In this case, for the switch-over a rotation speed synchronization in the shifting device 27 is carried out by the electric machine 4, and when the switch-over has been completed the condition IV has been reached, so that both of the electric machines 3 and 4 participate in the gear G2.

A downshift under load from the second gear G2 to the first gear G1 can then take place conversely to what has been described above. If in addition higher driving speeds are required than are acceptable in the second gear G2, then after the condition IV has been obtained a further switch-over is carried out in the shifting device 27 and this produces the condition V in order to produce the third gear G3.

Apart from a powershift between the gears G1 and G2, however, gearshifts with traction force interruption can also be carried out. For that purpose, starting from condition I the torque of the electric machines 3 and 4 is reduced until in its first gear engagement position the coupling element 28 of the shifting device 26 becomes free from load, whereupon the coupling element 28 is changed to its neutral position. This produces the condition VIII in which no gear is engaged. Thereafter, rotation speeds of the electric machines 3 and 4 are adjusted in such manner that the rotation speeds in the shifting device 26 are synchronized so as to enable the coupling element 28 to move to its second gear engagement position and thereby reach the condition IV. After that, a shift to the condition V is carried out analogously as described earlier, in order to engage the third gear G3.

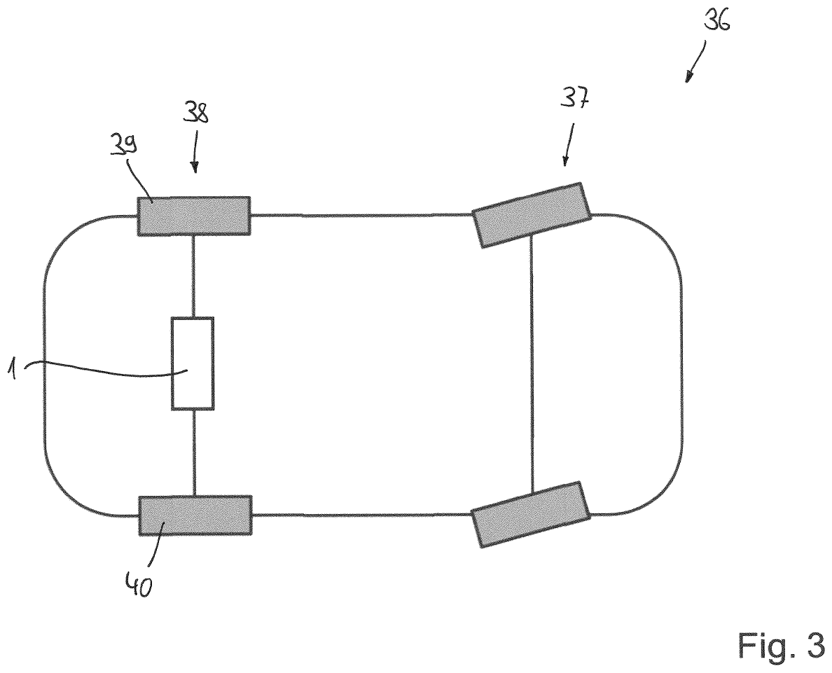

Finally, FIG. 3 shows a schematic view of an electric vehicle 36. Besides a steerable non-driven vehicle axle 37 the electric vehicle 36 also comprises a motor vehicle drive axle 38 with drive wheels 39 and 40. Part of the motor vehicle drive axle is also the drive unit 1, wherein the drive wheels 39 and 40 are coupled to the drive output shafts of the drive unit 1 by way of a differential gearset—not shown.

Whereas the vehicle axle 37 is a front axle of the element vehicle 36, the motor vehicle drive axle 38 is a rear axle thereof. However, alternatively or in addition to the vehicle drive axle 38 the vehicle axle 37 too could be designed as a drive axle, if necessary, with a drive unit of analogous structure.

By virtue of the designs according to the invention, a compactly configured motor vehicle transmission can be provided, with which a suitable connection of two drive machines is possible.

### INDEXES

1 Drive unit
2 Motor vehicle transmission
3 Electric machine
4 Electric machine
5 Stator
6 Stator
7 Rotor
8 Rotor
9 Drive input shaft
10 Drive input shaft
11 Drive output shaft
12 Sun gear
13 Sun gear
14 Planetary carrier
15 Planetary carrier
16 Ring gear
17 Ring gear
18 Planetary gearwheel
19 Planetary gearwheel
20 Connection point
21 Shaft
22 Permanently immobilized structural element
23 Connection point
24 Connection point
25 Shaft
26 Shifting device
27 Shifting device
28 Coupling element
29 Tooth array
30 Tooth array
31 Tooth array
32 Coupling element
33 Tooth array
34 Tooth array
35 Tooth array
36 Electric vehicle
37 Vehicle axle
38 Motor vehicle drive axle
39 Drive wheel
40 Drive wheel
P1 First planetary gearset
P2 Second planetary gearset
E11 First element of the first planetary gearset
E21 Second element of the first planetary gearset
E31 Third element of the first planetary gearset
E12 First element of the second planetary gearset
E22 Second element of the second planetary gearset
E32 Third element of the second planetary gearset
A Shifting element
B Shifting element
D Shifting element
E Shifting element
G1 First gear
G2 Second gear
G3 Third gear
I to VIII Conditions

1. A motor vehicle transmission (2) for an at least partially electrically driven motor vehicle, comprising:
a first drive input shaft (9);
a second drive input shaft (10);
a drive output shaft (11);
a first planetary gearset (P1); and
a second planetary gearset (P2);
exactly two shifting devices consisting of a first shifting device (26) and a second shifting device, the two shifting devices configured to engage various gears (G1, G2);
wherein the first drive input shaft (9) is configured for connection to a first drive machine, and the second drive input shaft (10) is configured for connection to a second drive machine;
wherein the first planetary gearset (P1) and the second planetary gearset (P2) each comprise a first element (E11, E12), a second element (E21, E22), and a third element (E31, E32), respectively, in the form of a sun gear (12, 13), a planetary carrier (14, 15), and a ring gear (16, 17),
wherein the first shifting device (26) comprises a first coupling element (28) which can be positioned in precisely two different gear engagement positions consisting of a first gear engagement position and a second gear engagement position, and which, in the second gear engagement position, the first shifting device connects the third element (E31) of the first planetary gearset (P1) rotationally fixed to the drive output shaft (11),
wherein the second element (E21) of the first planetary gearset (P1) is connected rotationally fixed to the first element (E12) of the second planetary gearset (P2), and
wherein the second element (E22) of the second planetary gearset (P2) is connected rotationally fixed to the drive output shaft (11),
wherein the third element (E32) of the second planetary gearset (P2) is immobilized,
wherein the second shifting device (27) comprises a second coupling element (32) which can be positioned in precisely two gear engagement positions consisting of a first gear engagement position and a second gear engagement position, wherein in the first gear engagement position, the second coupling element (32) connects the third element (E31) of the first planetary gearset (P1) rotationally fixed to the second drive input shaft (10) and in the second gear engagement position, the second shifting device connects the first drive input shaft (9) and the second drive input shaft (10) rotationally fixed to one another, and
wherein in the first gear engagement position, the first coupling element (28) immobilizes the third element (E31) of the first planetary gearset (P1).

2. The motor vehicle transmission (2) according to claim 1, wherein the first shifting device (26) is arranged axially on a side of the first planetary gearset (P1) facing away from the second planetary gearset (P2).

3. The motor vehicle transmission (2) according to claim 2, wherein the second shifting device (27) is positioned axially at least overlapping with, and radially surrounding the first planetary gearset (P1).

4. The motor vehicle transmission (2) according to claim 1, wherein the first coupling element (28) of the first shifting device (26) can also be positioned in a neutral position between the first gear engagement position and the second gear engagement position, in which the first coupling element (28) neither connects the third element (E31) of the first planetary gearset (P1) rotationally fixed to the drive output shaft (11) nor immobilizes the third element (E31) of the first planetary gearset (P1).

5. The motor vehicle transmission (2) according to claim 1, wherein the second coupling element (32) of the second shifting device (27) can also be positioned in a neutral position between the first gear engagement position and the second gear engagement position, wherein in the neutral position the second coupling element (32) neither connects the third element (E31) of the first planetary gearset (P1) rotationally fixed to the second drive input shaft (10) nor connects the first drive input shaft (9) and the second drive input shaft (10) rotationally fixed to one another.

6. A drive unit (1) for an at least partially electrically driven motor vehicle, comprising:
a first electric machine (3);
a second electric machine (4); and the motor vehicle transmission (2) according to claim 1, wherein the first electric machine (3) has a first rotor coupled to the first drive input shaft (9) of the motor vehicle transmission (2) and the second electric machine (4) has a second rotor coupled to the second drive input shaft (10) of the motor vehicle transmission (2).

7. The drive unit (1) according to claim 6, wherein the first planetary gearset (P1) is arranged axially at least partially overlapping with and radially inside the rotor (7) of the first electric machine (3).

8. The drive unit (1) according to claim 6, wherein the second planetary gearset (P2) is arranged axially at least partially overlapping with and radially inside the rotor (8) of the second electric machine (4).

9. The drive unit (1) according to claim 6, wherein the second shifting device (27) of the motor vehicle transmission (2) is arranged axially at least partially overlapping with and radially inside the rotor (8) of the second electric machine (4).

10. A motor vehicle drive axle (38) for a hybrid or electric vehicle (36), comprising a drive unit (1), comprising:
a first electric machine (3);
a second electric machine (4); and
the motor vehicle transmission (2) according to claim 1, wherein the first electric machine (3) has a first rotor coupled to the first drive input shaft (9) of the motor vehicle transmission (2) and the second electric machine (4) has a second rotor coupled to the second drive input shaft (10) of the motor vehicle transmission (2)

11. A hybrid or electric vehicle (36), comprising at least one drive unit (1), the at least one drive unit comprising:
a first electric machine (3);
a second electric machine (4); and
the motor vehicle transmission (2) according to claim 1, wherein the first electric machine (3) has a first rotor coupled to the first drive input shaft (9) of the motor vehicle transmission (2) and the second electric machine (4) has a second rotor coupled to the second drive input shaft (10) of the motor vehicle transmission (2).

12. A method for operating a motor vehicle transmission (2) according to claim 1, the method comprising;
engaging a first gear (G1) between the first drive input shaft (9) and the drive output shaft (11) when the first coupling element (28) is moved to the first gear engagement position;
engaging the first gear (G1) at the same time between the two drive input shafts (9, 10) and the drive output shaft (11), when in addition to the first coupling element (28) moving to the first gear engagement position, engaging the first gear includes moving the second coupling element (32) to the second gear engagement position;
engaging a second gear (G2) between the first drive input shaft (9) and the drive output shaft (11), when the first coupling element (18) is moved to the second gear engagement position; and
engaging the second gear (G2) at the same time between the two drive input shafts (9, 10) and the drive output shaft (11), when in addition to the first coupling element (28) moving to the second gear engagement position, engaging the second gear includes moving the second coupling element (32) to the second gear engagement position.

13. The method according to claim 12, wherein in the two shifting devices (26, 27), only the second coupling element (32) is moved to its first gear engagement position and thereby a superimposed operation mode of the drive input shafts (9, 10) is obtained at the first planetary gearset (P1) and/or a third gear (G3) is engaged between the two drive input shafts (9, 10) and the drive output shaft (11).

14. A method for operating a drive unit (1) according to claim 6, the method comprising:
shifting under load between a first gear (G1) of the motor vehicle transmission (2) acting between the two drive input shafts (9, 10) and the drive output shaft (11) and a second gear of the motor vehicle transmission (2) acting between the two drive input shafts (9, 10) and the drive output shaft (11);
switching the second coupling element (32) at the beginning of the shifting under load, in the second shifting device (27) of the motor vehicle transmission (2), from the second gear engagement position to the first gear engagement position, including carrying out a rotation speed synchronization in the second shifting device (27) by the second electric machine (4) and supporting a traction force by the first electric machine (3);
thereafter, moving the first coupling element (28) in the first shifting device (26) out of a current gear engagement position to the neutral position, including producing a load-free state of the first coupling element (28) by interaction of the two electric machines (3, 4);
moving, in the first shifting device (26), the first coupling element (28) from the neutral position to a target gear engagement position, including carrying out a rotation speed synchronization in the first shifting device (26) by the first electric machine (3); and
finally, switching, in the second shifting device (27) of the motor vehicle transmission (2), the second coupling element (32) from the first gear engagement position to the second gear engagement position, including carrying out a rotation speed synchronization in the second shifting device (27) by the second electric machine (4) and supporting a traction force is by the first electric machine (3).

15. A method for operating a drive unit (1) according to claim 6, the method comprising:
shifting from a first gear (G1), acting between the two drive input shafts (9, 10) and the drive output shaft (11) of the motor vehicle transmission (2), to a second gear (G2), acting between the two drive input shafts (9, 10) and the drive output shaft (11) of the motor vehicle transmission (2);
moving the first coupling element (28) in the first shifting device (26) from a current gear engagement position to the neutral position, including producing a load-free state of the first coupling element (28) by interaction of the two electric machines (3, 4); and
and thereafter, moving the first coupling element (28) in the first shifting element (26) from the neutral position to a target gear engagement position, including carrying out a rotation speed synchronization in the first shifting device (26) by the two electric machines (3, 4).

16. The method according to claim 14, further comprising:
shifting into a third gear (G3), as a function of rotation speeds of the two electric machines (3, 4), in the second gear (G2) acting between the two drive input shafts (9, 10) and the drive output shaft (11);
switching the second coupling element (32) in the second shifting device (27) from the second gear engagement position to the first gear engagement position, including carrying out a rotation speed synchronization in the second shifting device (27) by the second electric machine (4) and supporting a traction force by the first electric machine (3); and
then, moving the first coupling element (28) in the first shifting device (26) out of the second gear engagement position to the neutral position, including producing a load-free condition of the first coupling element (28) by interaction between the two electric machines (3, 4).

17. The method according to claim 15, further comprising:
shifting into a third gear (G3), as a function of rotation speeds of the two electric machines (3, 4), in the second gear (G2) acting between the two drive input shafts (9, 10) and the drive output shaft (11);
switching the second coupling element (32) in the second shifting device (27) from the second gear engagement position to the first gear engagement position, including carrying out a rotation speed synchronization in the second shifting device (27) by the second electric machine (4) and supporting a traction force by the first electric machine (3); and
then, moving the first coupling element (28) in the first shifting device (26) out of the second gear engagement position to the neutral position, including producing a load-free condition of the first coupling element (28) by interaction between the two electric machines (3, 4).

18. The motor vehicle transmission according to claim 1, wherein the first drive machine is a first electric machine, and the second drive machine is a second electric machine.
